(19) United States
(12) Patent Application Publication
(10) Pub. No.: US 2024/0427901 A1
(43) Pub. Date: Dec. 26, 2024

(54) EVENT-BASED CONTAINER IMAGE VULNERABILITY SCANNING

(71) Applicant: International Business Machines Corporation, Armonk, NY (US)

(72) Inventors: Anuj Gupta, Gurgaon (IN); Mayank Sharma, BANGALORE (IN); Gaurav Kumar Arora, Greater Noida West (IN)

(21) Appl. No.: 18/341,094

(22) Filed: Jun. 26, 2023

(51) Int. Cl. G06F 21/57; G06F 9/455

(52) U.S. Cl. CPC G06F 21/577; G06F 9/45558; G06F 2009/45587; G06F 2221/034

(57) ABSTRACT

Methods and systems for container management include scanning layers of a first container image of a set of container images to generate scan metadata for the layers. Relationship information is generated that identifies relationships between a first set of layers of the first container image and layers of additional container images of the plurality of container images. The additional container images are scanned, omitting any layers in the additional container images that match a layer of the first set of layers based on the relationship information.

### BACKGROUND

The present invention generally relates to containerized computing and, more particularly, to security scans for containerized systems.

Containerized computer systems make use of a variety of images to rapidly deploy new systems, for example in a cloud computing environment. A given containerized system may include thousands of container images, each of which has the potential for exposing security vulnerabilities. In addition, these container images may change over time as developers work on them, and new vulnerabilities may be discovered over time, so that the security exposure of a given system is constantly changing.

### SUMMARY

A method for container management includes scanning layers of a first container image of a set of container images to generate scan metadata for the plurality of layers. Relationship information is generated that identifies relationships between a first set of layers of the first container image and layers of additional container images of the plurality of container images. The additional container images are scanned, omitting any layers in the additional container images that match a layer of the first set of layers based on the relationship information.

A system for container management includes a hardware processor a memory that stores a computer program. When executed by the hardware processor, the computer program causes the hardware processor to scan a plurality of layers of a first container image of a plurality of container images to generate scan metadata for the plurality of layers. Relationship information is generated that identifies relationships between a first plurality of layers of the first container image and layers of additional container images of the plurality of container images. The additional container images are scanned, omitting any layers in the additional container images that match a layer of the first plurality of layers based on the relationship information.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a processing node in a containerized processing system that has per-layer scan sensitivity to reduce redundancy, in accordance with an embodiment of the present invention;

FIG. 2 is a block diagram of a pair of container images and the layers they share, in accordance with an embodiment of the present invention;

FIG. 3 is a block/flow diagram of a method for scanning layers in container images, in accordance with an embodiment of the present invention;

FIG. 4 is a block/flow diagram of a method for performing efficient security scans in a containerized processing system, in accordance with an embodiment of the present invention;

FIG. 5 is a block/flow diagram of a method for detecting and patching vulnerabilities responsive to a triggering event, in accordance with an embodiment of the present invention; and

FIG. 6 is a block diagram of a computer processing system that performs container security scanning, in accordance with an embodiment of the present invention.

### DETAILED DESCRIPTION

Security scans may be performed on the container images of a containerized computing system. Such scans may identify vulnerabilities within a container image, for example identifying a particular layer within the container image that includes a known vulnerability. Because a given system may include many container images, and because each container image may include multiple layers, the computational burden of running these security scans may represent a significant expense and may impose a substantial carbon footprint on the operation of the containerized computing system.

Security scans may be executed responsive to particular events and may further be executed periodically. For example, a scan may be executed on a container image whenever that container image is altered by a developer, to ensure that the altered container image does not include a new vulnerability. A scan may regularly furthermore be executed across multiple container images within the containerized system to identify any new vulnerabilities that have been discovered in the time since the last scan.

To decrease the burden of these security scans, metadata from the scans may be preserved to prevent redundant scanning. For example, multiple container images within the containerized computing system may share a particular layer. After that layer has been scanned for vulnerabilities in a first container image, the results of the scan may be cached and reused for other container images that use the same layer. When a given container image is altered, layers which have not been changed may be skipped in a security scan, as the metadata generated from a previous scan may be used.

By caching and reusing the metadata from container images that have not been changed, the amount of time and energy consumed by security scans can be significantly reduced. With fewer computational cycles being dedicated to security scans, the cost and environmental impact of performing the security scans is reduced.

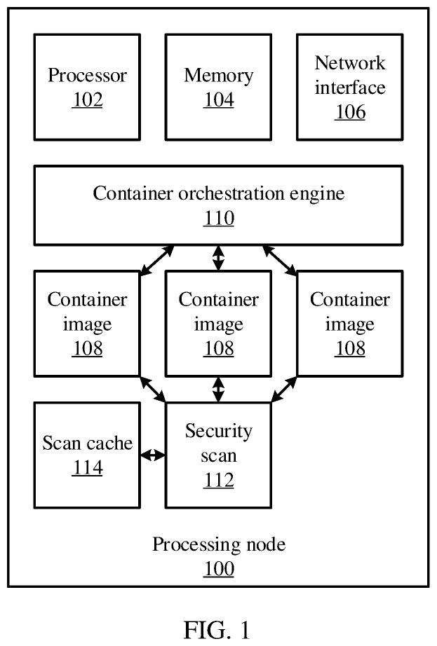

Referring now to FIG. 1, a processing node 100 in a containerized computing system is shown. It should be understood that the processing node 100 may be a standalone computing system, or may be part of a larger distributed system, such as a cloud computing system. The processing node 100 may be configured for a single task, or may provide multiple functions and/or services.

The processing node 100 includes a hardware processor 102, a memory 104, and a network interface 106. The network interface 106 may communicate with other processing nodes 100 as needed, using any appropriate communications medium and protocol. The processing node 100 also includes one or more functional modules that may, in some embodiments, be implemented as software that is stored in the memory 104 and that is executed by the hardware processor 102. In other embodiments, one or more of the functional modules may be implemented as one or more discrete hardware components in the form of, e.g., application-specific integrated chips or field programmable gate arrays.

The processing node 100 may include one or more container images 108. It is specifically contemplated that each container 108 represents a distinct operating environment, but in some cases multiple container images 108 may be used in tandem to implement a single operating environment or service. The container images 108 may each include a set of software applications, configuration files, workload datasets, and any other information or software needed to execute a specific workload. Each container image 108 may include a set of layers, which may for example represent respective changes to some base system layer. When a container image 108 is instantiated, all of its layers are implemented in order to produce the image.

The container images 108 are stored in memory 104 and are instantiated and decommissioned by the container orchestration engine 110 as needed. It should be understood that, as a general matter, an operating system of the processing node 100 exists outside the container images 108. Thus, each container image 108 interfaces with the same operating system kernel, reducing the overhead needed to execute multiple containers simultaneously. The container images 108 meanwhile generally have no communication with one another outside of specifically agreed-to interfaces, reducing security concerns.

A security scan 112 may be executed on the container images 108. The security scan 112 may be sensitive to the respective layers of the container images 108, with vulnerabilities being localized to particular layers. The security scan generates metadata that can be stored in a scan cache 114, for example within the memory 104. As layers may be reused between container images 108, the security scan 112 may skip the scan of layers that have been previously scanned and that have security metadata stored within the scan cache 114. While security scans are specifically contemplated, it should be understood that any sort of scan may be used instead. For example, scans that are instituted to ensure regulatory compliance may be used in place of, or in addition to, security scans. Another example of a scan that may be performed is one that optimizes layers of the container images for performance purposes. Another example of a scan that may be performed is one that identifies and updates software dependencies across the container images 108.

In an example, a container image security scan may look for security vulnerabilities by parsing through packages or other dependencies that are defined in a container image and checking whether there are any known vulnerabilities in those packages or dependencies. The scan may include a review of software packages, binaries, libraries, operating system files, and any other relevant component of the container image.

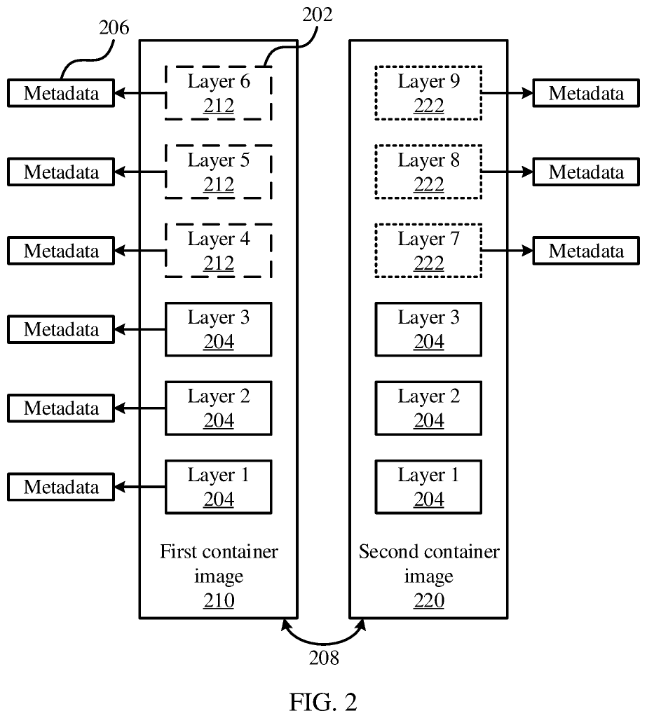

Referring now to FIG. 2, a comparison of two container images 108 is shown, including a first container image 210 and a second container image 220. The first container image 210 and the second container image 220 both include a respective set of layers 202. The layers 202 are combined together when the container image is instantiated to form an operational service.

The first container image 210 and the second container image 220 both include a set of shared layers 204, indicated with a solid border. These shared layers 204 may be identical to one another. The first container image 210 includes a set of first layers 212, indicated with a dashed border, and the second container image 220 includes a set of second layers 222, indicated with a dotted border. The first layers 212 combine with the shared layers 204 to create the operational environment of the first container image 210, while the second layers 222 combine with the shared layers 204 to create the operational environment of the second image.

When performing a security scan 112 on the first container image 210, each of the shared layers 204 and the first layers 212 may be scanned. Per-layer security metadata 206 may be generated during the scan 112 and may be stored in the scan cache 114. In this example, layers 1-6 from the first container image 210 would therefore have associated metadata 206 stored after the security scan 112.

When the second container image 220 is scanned, the list of layers in the second container image 220 may be compared to the metadata that is stored in the scan cache 114. For any layers that are present in the scan cache 114, the security scan 112 may skip those layers, scanning only the second layers 222. Per-layer metadata 206 associated with the second layers 222 may then be stored in the scan cache 114. For scans of any additional container images, layers matching the shared layers 202, the first layers 212, or the second layers 222 may be skipped.

In this example, the first container image 210 and the second container image 220 are related to one another by the shared layers 202. In addition to per-layer metadata, relationship information 208 may be gathered by the security scan 112 and may be stored in the scan cache 114. For example, this relationship information 208 may be stored in a graph database, with individual container images 108 being represented by graph nodes and with the relationship information 208 being represented by graph edges.

Within a given container image, the layers 202 are applied in an ordered fashion. For example, in the first container image 210, layer 1 may be applied first, followed by layer 2, and so on until all of the layers have been applied. Each layer thereby alters the operation of the container image relative to the layers before it. If a vulnerability is found in a given layer and is patched, the layers prior to the given layer in the container image are unaffected, while the layers after the given image will be affected by the patch.

In an example, the layers may be implemented as DOCKER® layers. DOCKER® images are built from a series of ordered build instructions. Each instruction in a Dockerfile roughly translates to a container image layer. Such layers may be files generated from running some command. Each step in a Dockerfile creates a new layer that may be understood as a difference generated in a filesystem relative to the previous layer. Layers may contain the state of the DOCKER® image at each milestone, and may be saved in local memory. Layers act as a cache, so if one instruction is changed in a Dockerfile and the image is rebuilt, only that instruction will be executed again. The rest of the layers will be cached and reused.

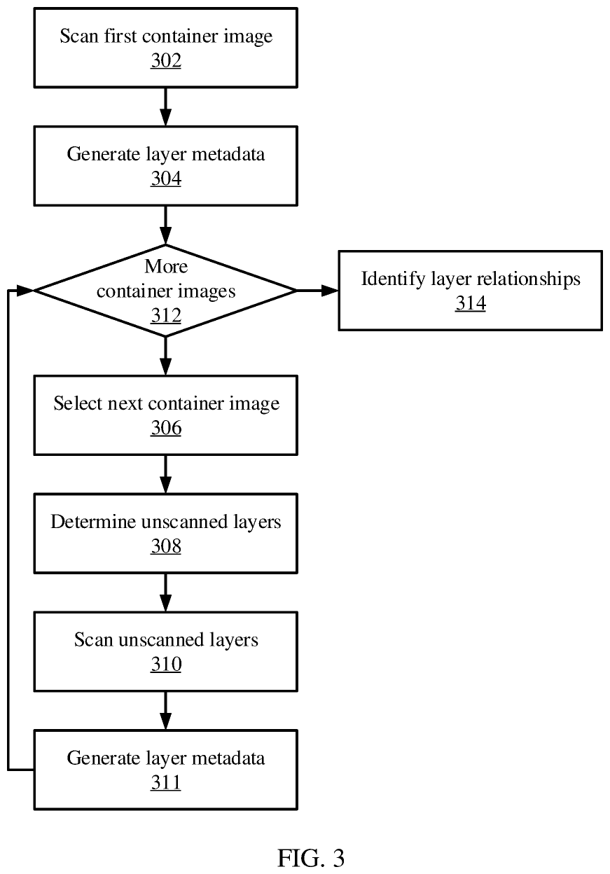

Referring now to FIG. 3, a scan process is shown for container images. Block 302 scans a first container image, for example any of a set of container images in a repository. The scan may use any appropriate layer-sensitive software tool and may include a security scan that looks for vulnerabilities in the container image. Block 304 generates per-layer metadata for each layer of the first container image, storing the metadata in the scan cache 114.

The scan may generate results for known vulnerabilities and may output a vulnerability score. The vulnerability score may identify a severity, impact, and risk for detected vulnerabilities. For example, consider a layer that has a vulnerability with a vulnerability score of 4, measured on a scale from 1 (least risk) to 10 (most risk), that vulnerability score will also apply to other container images that include the same layer. This can help to prioritize scans for other impacted images. In the event of a new, high-risk vulnerability, images containing that layer may be prioritized.

Block 312 determines whether there are more container images in the repository to scan. If so, then block 306 selects a next container image. Block 308 analyzes the layers of the next container image and determines which layers have not been scanned previously in other container images. Block 310 scans the previously unscanned layers and block 311 generates per-layer metadata based on the scan. Processing returns to block 312 to determine whether there are more container images to scan. When there are no further container images to scan, block 314 may identify layer relationships between the container images. These relationships may be used to generate a graph of the layer relationships between the container images in the repository.

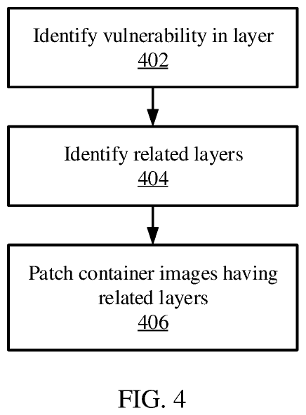

Referring now to FIG. 4, a process for identifying and patching vulnerabilities in a distributed computing system is shown. Block 402 identifies a vulnerability in a layer of a container image 108. This vulnerability may have been detected during a scan, as noted above, or may have been identified due to some advisory, for example a security advisory issued by a software vendor. As noted above, the layer that includes the vulnerability may be present in multiple container images 108. Rather than scanning each of the multiple container images 108 separately, the relationship information 208 may be used to quickly identify related layers in block 404. For example, block 404 may identify related layers by querying a graph database that stores layer relationship information.

Once the related layers are identified, the security vulnerability can be addressed. For example, the layer(s) in question may be patched to remove the vulnerability. In another example, the affected container images may be flagged as vulnerable, such that alternative container images, ones without the vulnerability, may be used instead.

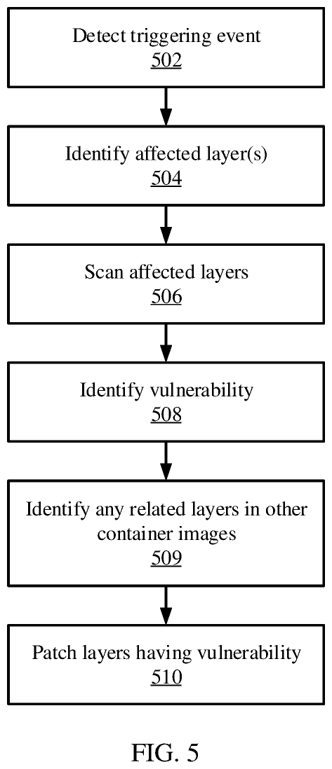

Referring now to FIG. 5, a process for event-driven security scanning is shown. Block 502 detects a triggering event. The triggering event may be, for example, a change made to a layer of a container image 108 by a developer, system operator, or any other entity. The triggering event may affect one or more layers of the container image 108. Block 504 identifies the layers affected by the triggering event. For example, if a given layer is changed by a developer, prior layers are not affected by the change, but subsequent layers may be affected.

A scan may be performed on the container image in block 506. This scan may be limited to layers that were affected by the triggering event. For the layers that were not affected, previously generated scan metadata may be called up from the scan cache 114 to complete the scan of the container image. The scan may identify a vulnerability of the affected layers in block 508.

The identified vulnerability may be present in other container images as well. For example, if the triggering event affects layers across multiple container images, then the identified vulnerability will be present in the other container images as well. Block 509 therefore identifies any related layers in other container images, using the stored relationship information. Block 510 may patch the affected layer(s) to close the vulnerability.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as container security scanning 690. In addition to block 200, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

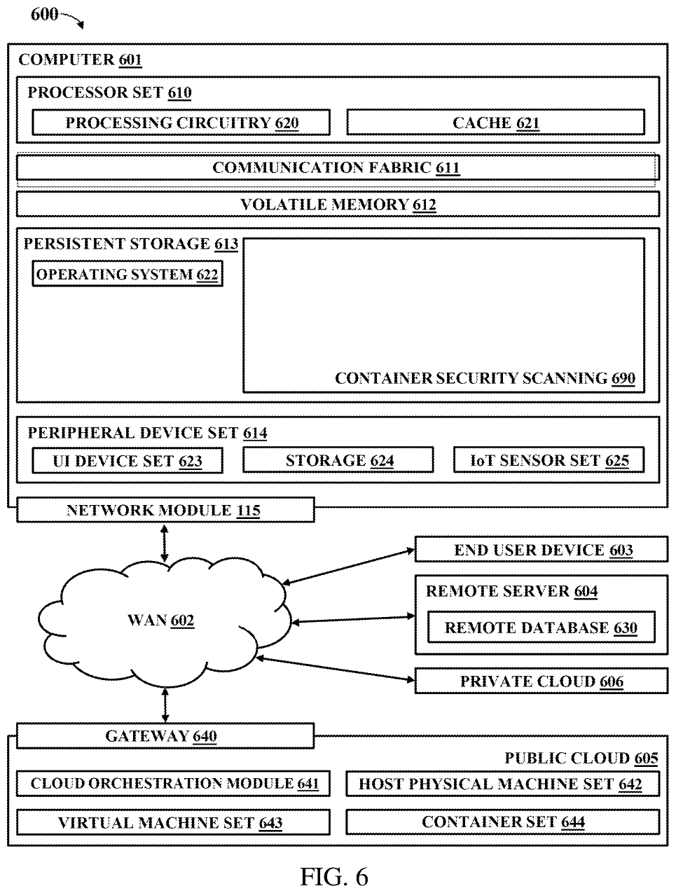

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 614 includes the set of peripheral devices of computer 601. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of event-based container image vulnerability scanning (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for container management, comprising:
scanning a plurality of layers of a first container image of a plurality of container images to generate scan metadata for the plurality of layers;
generating relationship information that identifies relationships between a first plurality of layers of the first container image and layers of additional container images of the plurality of container images; and
scanning the additional container images, omitting any layers in the additional container images that match a layer of the first plurality of layers based on the relationship information.

2. The computer-implemented method of claim 1, wherein scanning includes performing a security scan that identifies a vulnerability in a vulnerable layer of the first plurality of layers.

3. The computer-implemented method of claim 2, further comprising patching the vulnerable layer and layers of the additional container images that are related to the vulnerable layer based on the relationship information.

4. The computer-implemented method of claim 1, wherein the plurality of layers are DOCKER® layers.

5. The computer-implemented method of claim 1, further comprising detecting a triggering event that affects the first container image, wherein scanning the plurality of layers is performed responsive to the triggering event.

6. The computer-implemented method of claim 5, wherein the triggering event includes a change being made to the first container image.

7. The computer-implemented method of claim 6, wherein scanning the plurality of layers omits layers that are unaffected by the triggering event.

8. The computer-implemented method of claim 1, further comprising storing the relationship information in a graph database.

9. The computer-implemented method of claim 1, wherein the scan metadata includes a vulnerability score corresponding to a vulnerable layer of the plurality of layers, further comprising assigning the vulnerability score to any of the additional container images that include a layer that matches the vulnerable layer.

10. The computer-implemented method of claim 9, wherein scanning the additional container images includes prioritizing scans of the additional container images responsive to the vulnerability score.

11. A computer program product for container management, the computer program product comprising a computer readable storage medium having program instructions embodied therewith, the program instructions being executable by a hardware processor to cause the hardware processor to:
scan a plurality of layers of a first container image of a plurality of container images to generate scan metadata for the plurality of layers;
generate relationship information that identifies relationships between a first plurality of layers of the first container image and layers of additional container images of the plurality of container images; and
scan the additional container images, omitting any layers in the additional container images that match a layer of the first plurality of layers based on the relationship information.

12. A system for container management, comprising:
a hardware processor; and
a memory that stores a computer program which, when executed by the hardware processor, causes the hardware processor to:
scan a plurality of layers of a first container image of a plurality of container images to generate scan metadata for the plurality of layers;
generate relationship information that identifies relationships between a first plurality of layers of the first container image and layers of additional container images of the plurality of container images; and
scan the additional container images, omitting any layers in the additional container images that match a layer of the first plurality of layers based on the relationship information.

13. The system of claim 12, wherein the computer program further causes the hardware processor to perform a security scan that identifies a vulnerability in a vulnerable layer of the first plurality of layers.

14. The system of claim 13, wherein the computer program further causes the hardware processor to patch the vulnerable layer and layers of the additional container images that are related to the vulnerable layer based on the relationship information.

15. The system of claim 12, wherein the plurality of layers are DOCKER® layers.

16. The system of claim 12, wherein the computer program further causes the hardware processor to detect a triggering event that affects the first container image, wherein scanning the plurality of layers is performed responsive to the triggering event.

17. The system of claim 16, wherein the triggering event includes a change being made to the first container image.

18. The system of claim 17, wherein the computer program further causes the hardware processor to omit layers that are unaffected by the triggering event.

19. The system of claim 12, wherein the computer program further causes the hardware processor to store the relationship information in a graph database.

20. The system of claim 12, wherein the scan metadata includes a vulnerability score corresponding to a vulnerable layer of the plurality of layers, and wherein the computer program further causes the hardware processor to assign the vulnerability score to any of the additional container images that include a layer that matches the vulnerable layer.
